(19) United States
(12) Patent Application Publication
(10) Pub. No.: US 2005/0151361 A1
(43) Pub. Date: Jul. 14, 2005

(54) Steering support structure of vehicle

(75) Inventors: Tomohiro Hori, Hiroshima (JP); Tomoo Taguchi, Hiroshima (JP); Osamu Tabuchi, Hiroshima (JP)

Correspondence Address: NIXON PEABODY, LLP, 401 9TH STREET, NW, SUITE 900, WASHINGTON, DC, 20004-2128, US

(73) Assignee: Mazda Motor Corporation, Hiroshima (JP)

(21) Appl. No.: 11/028,869

(22) Filed: Jan. 5, 2005

(30) Foreign Application Priority Data
Jan. 14, 2004 (JP) 2004-006437
Jan. 20, 2004 (JP) 2004-011425
Jan. 21, 2004 (JP) 2004-012693

(51) Int. Cl. B62D 5/04

(52) U.S. Cl. 280/775

(57) ABSTRACT

There is provided the steering support structure of the vehicle, comprising the dash panel provided at the front portion in the cabin where the driver seat for the passenger is provided, the steering support member provided behind the dash panel and extending in the vehicle width direction, the steering shaft supported by the steering support member the steering device coupled to the front end portion of the steering shaft, the steering wheel attached to the rear end portion of the steering shaft, wherein the steering wheel is provided so as to face the shoulder portion of the passenger on the driver seat, and the steering shaft is provided above the steering support member and attached to the steering support member.

### BACKGROUND OF THE INVENTION

The present invention relates to a steering support structure of a vehicle in which a steering shaft, whose front end portion is coupled to a steering device and whose rear end portion is attached to a steering wheel, is supported at a steering support member extending in a vehicle width direction.

Conventionally, a structure illustrated in FIG. 16 is known as such a steering support structure of a vehicle. Namely, there is provided a steering support structure of a vehicle, comprising a dash panel provided at a front portion in a cabin 101 where a driver seat 100 for a passenger A is provided, a steering support member 102 provided behind the dash panel and extending in the vehicle width direction, and a steering shaft 104, whose front end portion is coupled to a steering device and whose rear end portion is attached to a steering wheel 103, wherein the steering shaft 104 is provided below the steering support member 102 and attached to the steering support member 102.

Also, the steering wheel 103 is provided so as to incline relative to a vertical line 106 by an angle θb (e.g., approximately 23 degrees) in order to place a meter 105 at an instrument panel and provide a proper visibility for the passenger.

This conventional steering support structure of a vehicle has a proper meter visibility, but has the following problems. Namely, since the steering wheel 103 inclines forward by the angle θb, there was a problem that a sufficient adjustment of the steering wheel 103 cannot be obtained in a longitudinal direction of the vehicle according to a body size of the passenger. Further, a distance from a driver's hand located at an upper portion of the steering wheel 103 to the driver's shoulder portion is relatively long, whereas a distance from a driver's hand located at a lower portion of the steering wheel 103 to the driver's shoulder portion is relatively short. Thus, the difference between the above-described distances is relatively large. As a result, a handling of the steering wheel 103 deteriorates and a sense of fatigue of the passenger A deteriorates as well.

Meanwhile, the Japanese Patent Laid-Open Publication No. 7-52809 discloses that a steering shaft is supported at a lower portion of a steering support member extending in the vehicle width direction via a steering hanger, and a steering wheel attached to a rear end of the steering shaft is inclined forward. This steering support structure, however, is substantially the same as the one illustrated in FIG. 16, and thus it had the same problems.

### SUMMARY OF THE INVENTION

The present invention has been devised in view of the above-described problems. An object of the present invention is to provide a steering support structure of a vehicle in which the difference between the distance from the driver's hand located at the upper portion of the steering wheel to the driver's shoulder portion and the distance from the driver's hand located at the lower portion of the steering wheel to the driver's shoulder portion becomes extremely small, and thus the handling of the steering wheel can be improved, the sense of fatigue of the passenger can be reduced, and the steering wheel can be properly adjusted in the longitudinal direction of the vehicle according to the body size of the passenger.

According to the present invention, there is provided a steering support structure of a vehicle, comprising a dash panel provided at a front portion in a cabin where a seat for a passenger is provided, a steering support member provided behind the dash panel and extending in a vehicle width direction, a steering shaft supported by the steering support member, a steering device coupled to a front end portion of the steering shaft, a steering wheel attached to a rear end portion of the steering shaft, wherein the steering wheel is provided so as to face a shoulder portion of the passenger on the seat, and the steering shaft is provided above the steering support member and attached to the steering support member.

Accordingly, since the steering wheel is provided so as to face the shoulder portion of the passenger, the difference between the distance from the driver's hand located at the upper portion of the steering wheel to the driver's shoulder portion and the distance from the driver's hand located at the lower portion of the steering wheel to the driver's shoulder portion becomes extremely small. As a result, the handling of the steering wheel can be improved, the sense of fatigue of the passenger can be reduced, and the steering wheel can be properly adjusted in the longitudinal direction of the vehicle according to the body size of the passenger. Namely, the proper disposition of the steering wheel with the reduced sense of fatigue can be attained.

According to a preferred embodiment, the steering shaft is configured such that a position thereof is adjustable, and there is provided a meter portion which moves along with the steering shaft and whose position is adjustable. The position of the steering shaft can be adjusted in both tilt and telescopic directions.

Accordingly, since the steering shaft and the meter portion move together, both the proper disposition of the steering wheel and the proper visibility of the meter can be obtained.

According to another preferred embodiment, there is provided a steering attaching bracket to attach the steering shaft to the steering support member, and the steering shaft is fixed to the steering support member by fastening the steering attaching bracket from below.

Accordingly, since the both (the steering shaft and the steering support member) are fixed by fastening the steering attaching bracket from below, the service of the steering shaft can be facilitated.

According to another preferred embodiment, there is provided an instrument panel above the steering shaft, and the instrument panel is configured such that a part thereof is detachable, whereby the steering shaft can be detached by detaching the part of the instrument panel.

Accordingly, all of the instrument panel does not need to be detached, and by detaching only part, the steering shaft can be removed. Accordingly, the maintenance and service can be facilitated.

According to another preferred embodiment, this part of the instrument panel is provided at the meter portion.

Accordingly, all of the instrument panel does not need to be detached, and by detaching only the meter portion, the steering shaft can be removed. Accordingly, the maintenance and service can be facilitated. Also, this detachable structure of the meter portion can simplify a structure around the instrument panel. Further, since there is provided no unnecessary slit structure, an appearance will not deteriorate.

According to another preferred embodiment, the meter portion comprises a meter body and a meter hood which are integrally attached.

Accordingly, since the meter body and the meter hood are integrally attached or detached, the maintenance and service can be further facilitated.

According to another preferred embodiment, there is further provided an operating member which pulls an intermediate portion of the steering shaft rearward during a vehicle frontal crash.

Accordingly, since the operating member pulls the intermediate portion of the steering shaft rearward during the vehicle frontal crash, the safety of the passenger can be ensured by the control of the steering shaft.

Namely, both the proper disposition of the steering wheel, which provides the steering wheel with the proper longitudinal adjustment and the reduced sense of fatigue, and the safety of the passenger by the control of the steering shaft can be obtained.

According to another preferred embodiment, the steering shaft comprises a plurality of shafts which are coupled via a joint portion, the operating member pulls the steering shaft such that the steering shaft is bent rearward during the vehicle frontal crash. The joint portion may be configured of a steering joint such as an universal joint.

Accordingly, when the steering shaft is pulled rearward by the operating member during the vehicle frontal crash, the pull is carried out by making use of the joint portion. Thus, the safety by the control of the steering shaft can be ensured further properly.

According to another preferred embodiment, the operating member is attached at the dash panel which is moved rearward during the vehicle frontal crash.

Accordingly, since the operating member is attached at the dash panel which is moved rearward first during the vehicle frontal crash, the steering shaft can be pulled rearward at the appropriate timing.

According to another preferred embodiment, the operating member is attached to a pedal support bracket which is attached at the dash panel to support the pedal and is moved rearward and then slant downward during vehicle frontal crash. This pedal support bracket is configured so as to be a structure to prevent the pedal from being moved rearward.

Accordingly, since the pedal support bracket, which is moved rearward and then slant downward during vehicle frontal crash, is utilized, the steering shaft can be pulled rearward surely without interfering with any other member when the operating member pulls the steering shaft. Also, this structure can be made simple.

According to another preferred embodiment, there is further provided an engaging member which prevents the operating member from sliding at a portion of the steering shaft which corresponds to the operating member.

Accordingly, since the operating member is prevented from sliding by the engaging member, the pull of the steering shaft by the operating member can be attained further surely.

According to another preferred embodiment, there is further provided an expanding portion which is expandable in an axial direction during the vehicle frontal crash at the intermediate portion of the steering shaft.

Accordingly, the expanding portion provided at the intermediate portion of the steering shaft expands in the axial direction during the vehicle frontal direction. Thus, the steering wheel can be prevented from moving toward the passenger, and thus the safety by the control of the steering shaft can be ensured.

According to another preferred embodiment, the intermediate portion of the steering shaft comprises a plurality of shafts which are connected with an overlap. These shafts may be configured of an outer shaft and an inner shaft which can covey the steering force by the steering wheel and move relatively in the axial direction.

Accordingly, the expanding portion which is expandable at least in the axial direction during the vehicle frontal crash can be made simple.

According to another preferred embodiment, this expanding portion is configured so as to be separated after its expansion.

Accordingly, since the expanding portion is separated after its expansion, the control of the steering shaft can be attained further surely, and the safety of the passenger can be ensured further properly.

According to another preferred embodiment, there is further provided an operating member to promote the expansion and separation of the expanding portion by pulling the intermediate portion of the steering shaft rearward during the vehicle frontal crash. The operating member may be configured of a hook member which pulls the intermediate portion of the steering shaft rearward.

Accordingly, since the expansion and separation of the expanding portion is promoted by the operating member, the expansion and separation can be attained surely.

Other features, aspects and advantages of the present invention will become apparent from the following description which refers to the accompanying drawings.

### BRIEF DESCRIPTION OF THE DRAWINGS

FIG. 1 is a side view illustrating a structure of passenger's shoulder facing a steering wheel.

FIG. 2 is a side view illustrating a steering support structure of a vehicle according to the present invention.

FIG. 3 is a schematic diagram illustrating the steering support structure.

FIG. 4 is a perspective view illustrating a column support structure comprising a steering attaching bracket.

FIG. 5 is an enlarged side view illustrating a structure of a meter portion which moves along with a steering shaft.

FIG. 6 is a plan view of a major part illustrating the steering support structure.

FIG. 7 is a plan view of FIG. 6.

FIG. 8 is an exploded perspective view illustrating a structure in which the steering shaft is pulled rearward.

FIG. 9 is a perspective view illustrating an attaching structure of a pedal control bracket and a backup bracket.

FIG. 10 is a sectional view of a second steering shaft.

FIGS. 11A, 11B and 11C are sectional views illustrating respective structures of the second steering shaft which can expand and separate.

FIG. 12 is a schematic diagram explaining an operation during a vehicle crash.

FIG. 13 is a side view illustrating a sate where the steering shaft is pulled rearward during the vehicle crash.

FIG. 14 is a side view illustrating a separated state of the second steering shaft.

FIG. 15 is a side view illustrating a steering support of a vehicle according to another embodiment of the present invention.

FIG. 16 is a side view schematically illustrating a conventional steering support shaft of a vehicle.

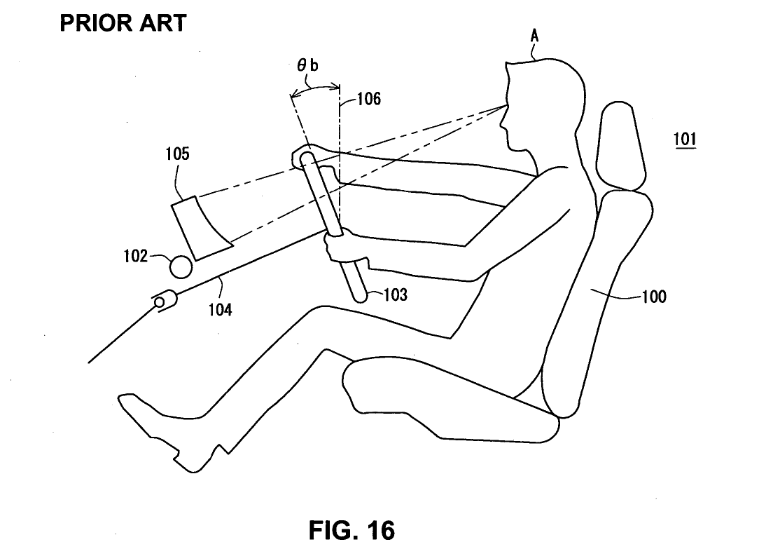

### DETAILED DESCRIPTION OF THE INVENTION

Hereinafter, preferred embodiments will be described in detail referring to the accompanying drawings. It should be understood that even though embodiments are separately described, single features thereof may be combined to additional embodiments.

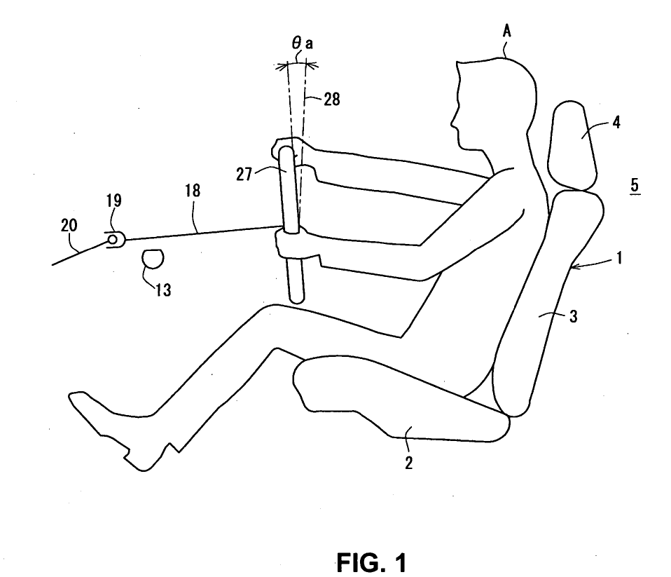

Figures illustrate a steering support structure of a vehicle, and there is provided a driver seat 1 as a seat on which a passenger A sits in FIGS. 1 through 3. The deriver seat 1 comprises a seat cushion 2, a seat back 3, and a headrest 4.

There is provided a dash lower panel 6 at a front portion of a cabin 5 in which the driver seat 1 and a passenger seat (not illustrated) are provided. The dash lower panel 6 separates the cabin from an engine room 7 in a longitudinal direction of the vehicle. A cowl box 8, which has a closed-section structure extending in a vehicle width direction, is attached to an upper portion of the dash lower panel 6. The cowl box 8 is a vehicle-body rigidity member, which comprises a cowl panel 9 and a dash upper panel 10 which are connected with each other to constitute a cowl closed section 11 extending in the vehicle width direction.

Also, there is provided a floor panel 12 which is connected with a lower portion of the dash lower panel 6 and extends rearward and substantially horizontally to form a floor portion. Further, in rear of the dash lower panel 6 is provided a steering support member 13 as a vehicle-body rigidity member extending in the vehicle width direction. The steering support member 13 interconnects right-and-left hinge pillars as a vehicle-body rigidity member.

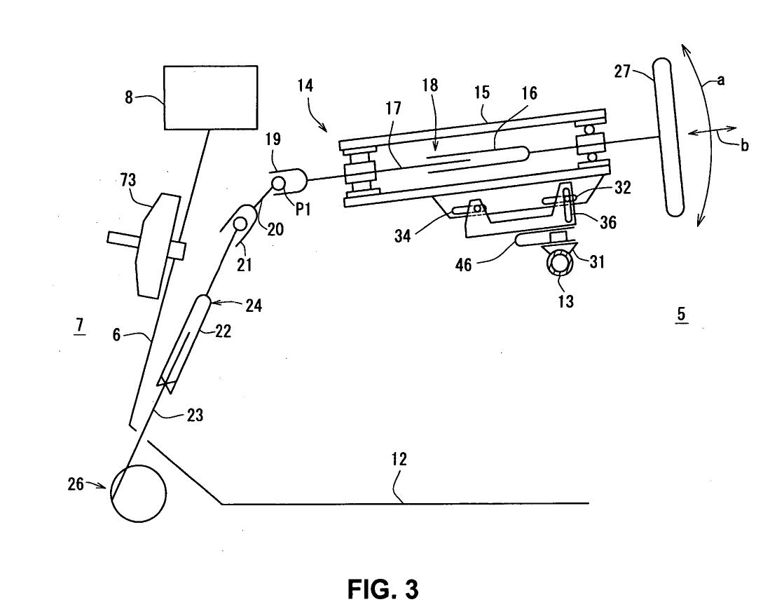

A steering shaft 14, which is supported at the steering support member 13, comprises the following members. Namely, as illustrated in FIG. 3, the steering shaft 14 comprises: a first steering shaft 18 which comprises an outer shaft 16 and an inner shaft 17, which are disposed in a steering column 15, and is 2nd-collapsible; a second steering shaft 20 (intermediate shaft) which is coupled to a front end of the first steering shaft 18 via a universal joint 19 as a steering joint; and a third steering shaft 24 (pinion input shaft) which is coupled to a front end of the second steering shaft 20 via a universal joint 21 as the steering joint and includes an outer shaft 22 and an inner shaft 23. Namely, the above-described steering shaft 14 comprises a plurality of shafts 18, 20 and 24 which are coupled via the joints.

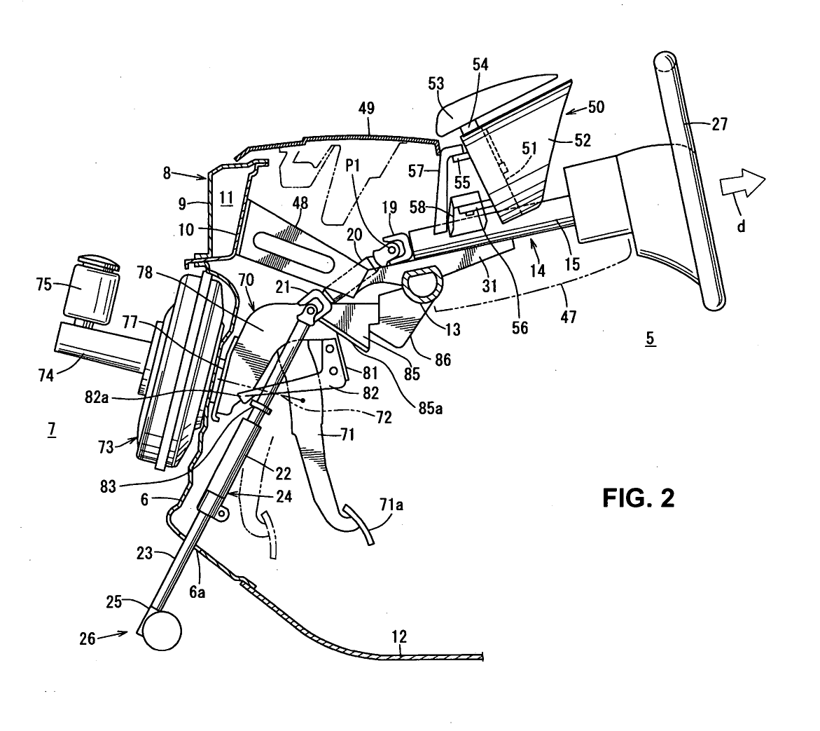

The inner shaft 23 of the third steering shaft 24 extends forward getting through an opening portion 6a at the dash lower panel 6 as illustrated in FIG. 2, a worm 25 at its extended end is engaged with a sector or a rack to constitute a steering gear, and right-and-left tie rods are coupled to the steering gear. Accordingly, a steering device 26 to steer right-and-left wheels is configured.

Also, a steering wheel 27, which is attached to a rear end of the outer shaft 16 of the first steering shaft 18, is provided so as to face a shoulder portion of the passenger A as illustrated in FIG. 1.

In the present embodiment, the steering wheel 27 is inclined by an angle θa (e.g., approximately 10 degree) relative to a vertical imaginary line 28 extending in a vertical direction. Further, the steering shaft 14 is supported at the steering support member 13 such that the first and second steering shafts 18 and 20 thereof are disposed above the steering support member 13.

By arranging the steering wheel 27 so as to face the shoulder portion of the passenger A described above, the difference between the distance from a driver's hand located at an upper portion of the steering wheel 27 to the driver's shoulder portion and the distance from a driver's hand located at a lower portion of the steering wheel 27 to the driver's shoulder portion becomes extremely small as illustrated in FIG. 1. As a result, a handling of the steering wheel 27 can be improved, a sense of fatigue of the passenger A can be reduced, and the steering wheel 27 can be properly adjusted in a longitudinal direction of the vehicle according to a body size of the passenger A.

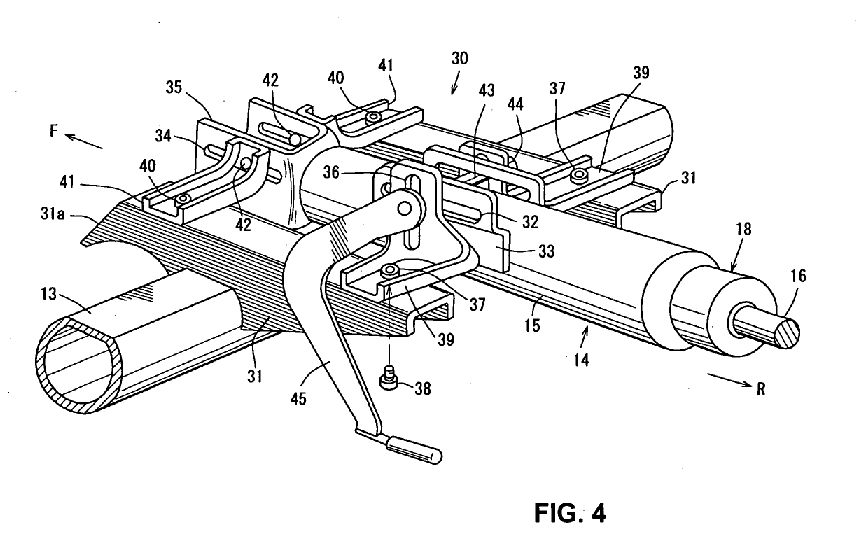

FIG. 4 illustrates a steering attaching bracket 30 fixing the steering shaft 14 to the steering support member 13, and the steering shaft 14 is adjustable in both a tilt direction (see an arrow a) and a telescopic direction (see an arrow b) by the steering attaching bracket 30 as illustrated in FIG. 3.

The steering attaching bracket 30 comprises: right-and-left support brackets 31 which are welded to both sides of the steering support member 13 and have U-shaped cross section; right-and-left brackets 33 which are directly fixed on both sides of the steering column 15 and have long holes 32 extending longitudinally; a U-shaped bracket 35 which is fixed to a front portion of the steering column 15 and have a proper size not so as to interfere with the universal joint 19 and long holes 34 extending longitudinally; right-and-left brackets 39 which are respectively formed in a L shape so as to extend between the support brackets 31 and the brackets 33, have long holes 36 extending vertically at their sides corresponding to the long holes 32, and are respectively fastened to the support brackets 31 via nuts 37 welded at the support brackets 31 and bolts 38 inserted from below the support bracket 31; and right-and-left brackets 41 which are respectively formed in a L shape so as to extend between the front portion of the support brackets 31 and the bracket 35 at the side of the steering column 15 and are respectively fastened to the support brackets 31 via nuts 49 welded at the support brackets 31 and bolts (not illustrated) inserted from below the support bracket 31.

Also, pins 42 are provided at sides of the brackets 41 located forward (front attaching brackets) which correspond to the long holes 34, and the pins 42 are inserted into the long holes 34 at the bracket 35 so as to slide. Meanwhile, an axis member 43 is provided at the bracket 39 located rearward (rear attaching brackets) so as to integrally penetrate the vertical long holes 36 and the longitudinal long holes 32 of the brackets 33. This axis member 43 is configured so as to be fastened and unfastened (locked and unlocked) by a nut 44 welded to the attaching bracket 39 and an adjusting lever 45 integrally coupled to one end of the axis member 43.

According to this structure, after the axis member 43 has been unfastened by the lever 45, the steering shaft 14 (specifically, the steering column 15 and first steering shaft 18) can be adjusted along the vertical long holes 36 in the arrow a direction (tilt) and also along the longitudinal long holes 32 and 34 in the arrow b direction (telescopic) of FIG. 3. And, after these tilt and/or telescopic adjustments has been done, the axis member 43 is fastened. Thus, the steering shaft 14 and the steering wheel 27 can be adjusted in their proper positions according to the body size of the passenger A.

Herein, there are respectively provided U-shaped plates 46 as an impact absorbing member between the support brackets 31 and the attaching brackets 41 and 39 as illustrated in FIG. 3, whose illustration is omitted in FIG. 4.

A structure of the steering attaching bracket 30, in which the steering shaft 14, specifically the steering column 15 is fixed to the steering support member 13 by the fastening from below as illustrated in FIG. 4, can facilitate the service of the steering shaft 14.

Also, as illustrated in FIG. 2, a specified portion of the steering column 15 is enclosed by a column cover 47, and there is provided a steering bracket 48 between a front-end slant portion 31a (see FIG. 4) and a rear face portion of the dash upper panel 10 at the cowl box 8.

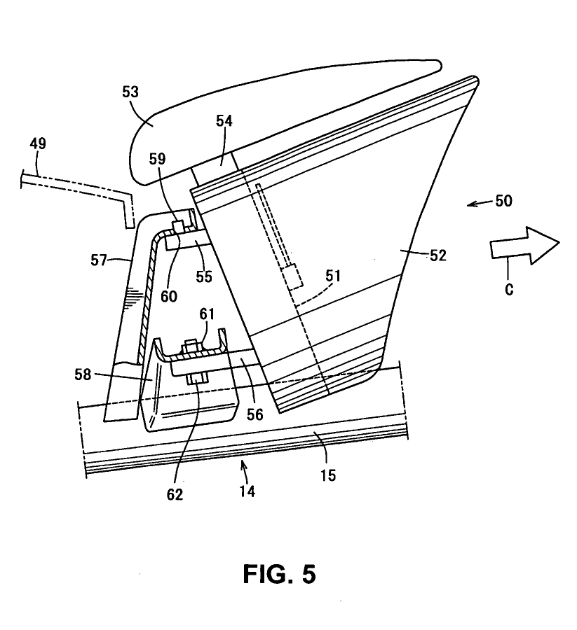

As illustrated in FIGS. 2 and 5, an instrument panel 49 is provided above the steering shaft 14, and a meter portion 50 as a part of the instrument panel 49 is detachably provided. The meter portion 50 comprises a meter body 51 including a vehicle speed meter, an engine speed mater and so on, a meter cover 52 and a meter hood 53. The meter cover 52 and the meter hood 53 are integrally connected by a connecting member 54.

The meter portion 50 is configured so as to be adjustable in position by moving along with the steering column 15 of the steering shaft 14 as illustrated in FIGS. 2 and 5. Namely, a single meter support upper 55 is provided at the center of a front upper portion of the meter body 51, and two meter support lower 56 are provided at both sides of front lower portion of the meter body 51 (only one thereof is illustrated).

Also, there are provided a single meter support bracket 57 as a center bracket extending upward from the steering column 15, and two meter support brackets 58 as side brackets extending toward both sides from the steering column 15 (only one thereof is illustrated). These meter support brackets 57 and 58 are formed so as to have a U-shaped cross section to ensure a sufficient rigidity thereof.

Further, a pin 59 extending upward is formed integrally on the meter support upper 55, and the meter support bracket 57 has a pin hole 60 to receive this pin 59 for a positional adjustment.

Also, nuts 61 are respectively welded to the meter support brackets 58, and then the both members 58 and 56 are fastened by bolts 62 into the nuts 61. In order to attach the meter portion 50 to the respective meter support brackets 57 and 58, the pin 59 at the meter support upper 55 is inserted into the pin hole 60 at the meter support bracket 57 to place the meter portion 50 temporarily, and then the bolts 62 are inserted into the nuts 61 via the meter support lower 56 from below and fastened into the nuts 61 of the meter support brackets 58. Thus, the meter portion 50 can be attached.

In order to detach the meter portion 50, after the column cover 47 (see FIG. 2) has been detached, the bolts 62 are took off and the pin 59 is took off downward, and then the meter hood 53, meter body 51 and meter cover 52 are pulled rearward (in an arrow direction c of FIG. 5) together. Thus, the meter portion 50 can be detached from the steering column 51 and the instrument panel 49.

Thus, since the steering shaft 14 and the meter portion 50 move together, both the proper disposition of the steering wheel 27 and the proper visibility of the meter can be obtained. Also, all of the instrument panel 49 does not need to be detached, and by detaching only the meter portion 50, the steering shaft 14 can be removed, thereby facilitating the maintenance and service. When the steering shaft 14 is detached, the engagement of the steering gear is once released, and after the bolts 38 are took off downward illustrated in FIG. 4, the steering shaft 14 is removed in an arrow direction d of FIG. 2.

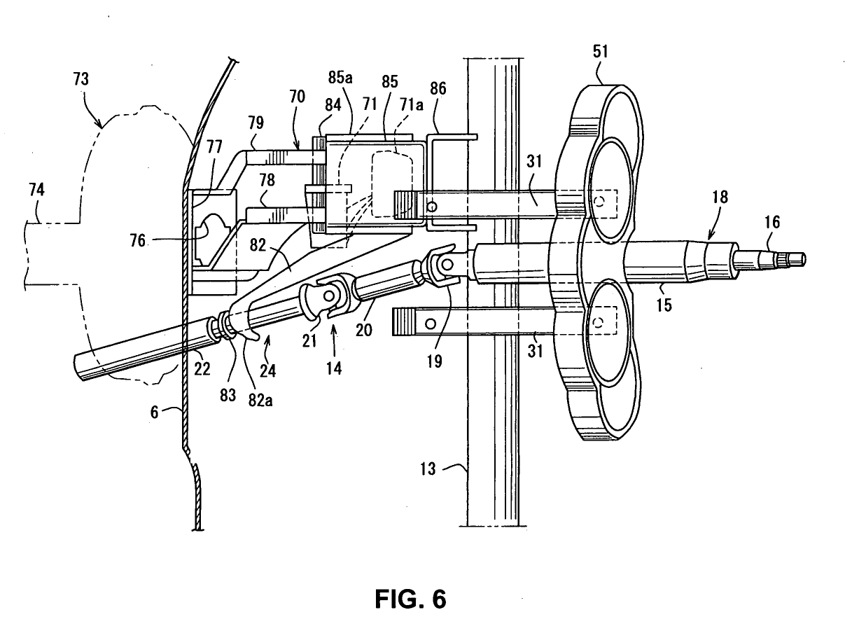

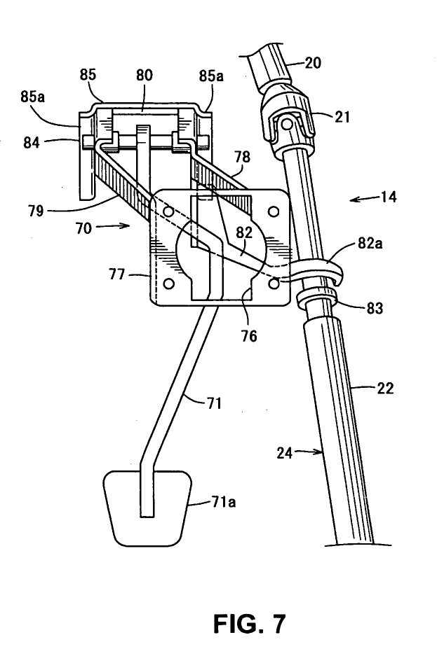

As illustrated in a side view of FIG. 2, a plan view of FIG. 6, and an elevation view of FIG. 7, a bake pedal 71 is rotatably supported at a pedal support bracket 70 which is attached to the dash lower panel 6. And, a valve operating rod 72 (illustrated by a two-dotted broken line) is coupled to the brake pedal 71, and a braking device 73 provided at the engine room 7 is operated via the valve operating rod 72 by pressing a pressing face 71a of the brake pedal 71.

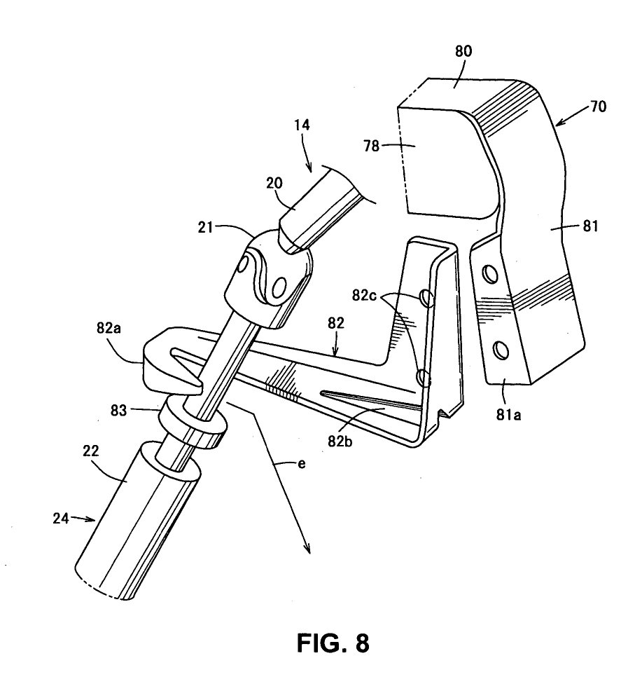

The above-described braking device 73 comprises a master cylinder 74 and a fluid reservoir 75, and a body thereof is attached to a front face of the dash lower panel 6. The pedal support bracket 70, as illustrated in FIGS. 2, 6, 7 and 8, is comprised of a front face plate 77 which has an opening 76 for allowing the valve operating rod 72 to get therethrough toward the brake pedal 71, right-and-left side face plate 78 and 79, an upper face plate 80 and a back face plate 81 which respectively interconnect the right-and-left side face plates 78 and 79. A bent portion 81a is formed integrally with the back face plate 81 of the pedal support bracket 70 as illustrated in FIG. 8, and a hook member 82 having a L shape, when viewed from the side, is attached to the bent portion 81a. The hook member 82 is a member to promote the expansion and separation of an expanding portion by moving rearward the center portion of the steering shaft 14, which will be described.

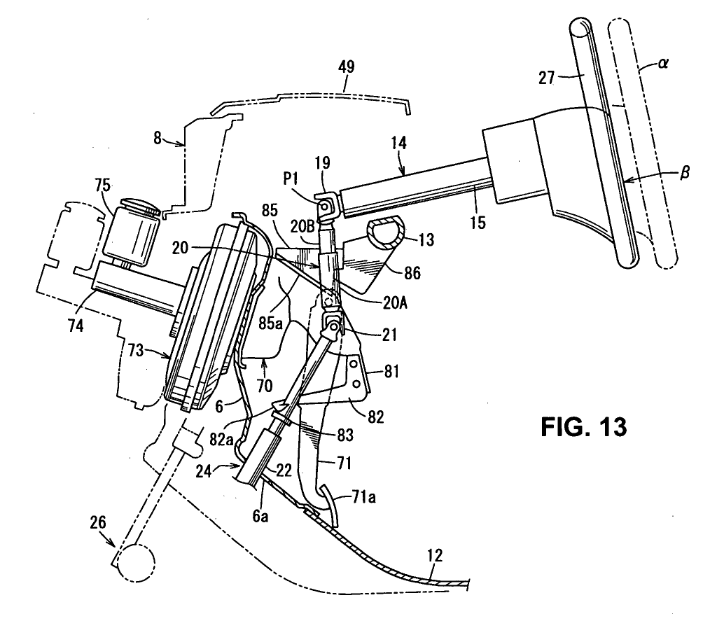

The hook member 82 includes a hook portion 82a having a hook shape at its front end, and, as illustrated in FIGS. 2, 6, 7 and 8, it is disposed such that the hook portion 82a is away from the outer shaft 22 of the third steering shaft 24 but can engage with the shaft 24 in a specified situation. Namely, when the vehicle has a frontal crash or the like, the hook member 82 functions as an operating member to pull the steering shaft 14 rearward by engaging the outer shaft 22 (see, particularly, the second and third steering shafts 20 and 24) (see FIG. 13).

The hook member 82 as the operating member includes a bead 82b to increase the rigidity of the member, and blot holes 82c and 82c are formed at the attaching portion of the bracket 70.

At a specified portion of the outer shaft 22 below the hook portion 82a is provided an engaging ring 83 as an engaging member which prevents the hook member 82 from sliding and ensures the pull of the steering shaft 14 by the hook member 82.

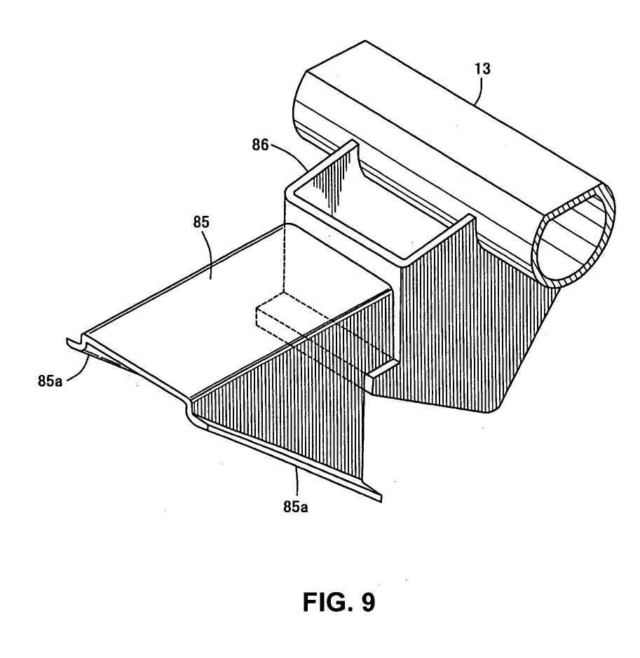

Also, an axis member 84 is fixed between the right-and-left side face plates 78 and 79 of the pedal support bracket 70 as illustrated in FIGS. 6 and 7. Further, a pedal control bracket 85 having a box shape opening downward is provided at an upper and rear portion of the pedal support bracket 70 (see FIG. 9), and a backup bracket 86 having a U shape is attached between the pedal control bracket 85 and the steering support member 13. Both brackets 85 and 86 are connected with each other by a bolt-and-nut or welding. Thus, the both brackets 85 and 86 (rigidity members) are configured so as not to change their positions during the vehicle frontal crash or the like.

Also, right-and-left guide pieces 85a and 85a which slant rearward and downward are formed integrally with lower ends of the pedal control bracket 85 as illustrated in FIGS. 2, 6, 7, and 9. When the dash lower panel 6 and the pedal support bracket 70 are moved rearward during the vehicle frontal crash or the like, the axis member 84 of the pedal support bracket 70 is guided along lower faces of the above-described guide pieces 85a and 85a, and the pedal support bracket 70 is bent as illustrated in FIG. 13. Thus, the brake pedal 71 is prevented from jumping up toward the feet of the passenger A. Also, the hook member 82 attached to the pedal support bracket 70 is moved in an arrow e direction (rearward and then slant downward) of FIG. 13, and the steering shaft 14 is pulled rearward and bent with a bending point of the universal joints 19 and 21 as the joint as illustrated in FIG. 13.

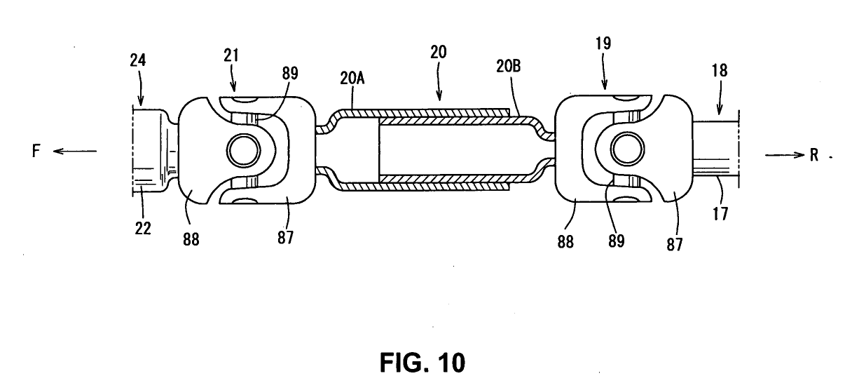

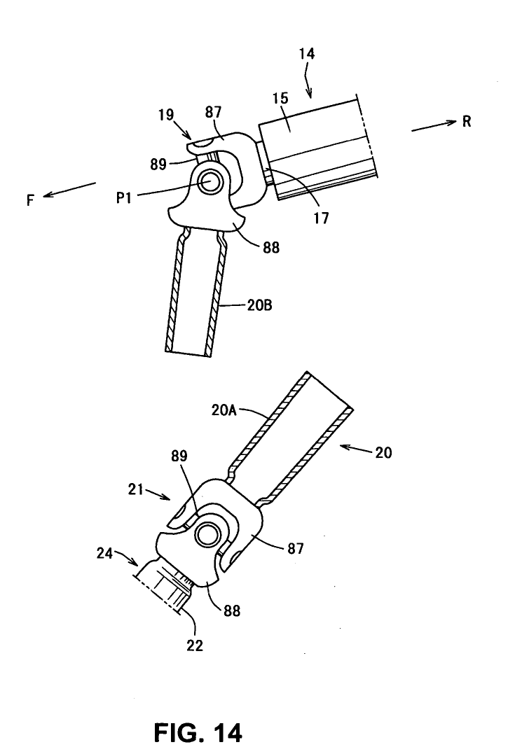

The above-described second steering shaft 20 comprises a plurality of outer shaft 20A and inner shaft 20B as illustrated in FIG. 10, and conveys a steering force (rotational force) by the steering wheel 27 to the third steering shaft 24 via the universal joint 19, inner shaft 20B, outer shaft 20A and universal joint 21. When the vehicle frontal crash or the like occur, the outer shaft 20A and the inner shaft 20B are moved relatively in the axial direction as illustrated in FIG. 13, and after these both shafts 20A and 20B have expanded, these shafts 20A and 20B are separated as illustrated in FIG. 14. Namely, the outer and inner shafts 20A and 20B of the second steering shaft 20 constitute the expanding portion which is expandable at least in the axial direction during the vehicle frontal crash or the like.

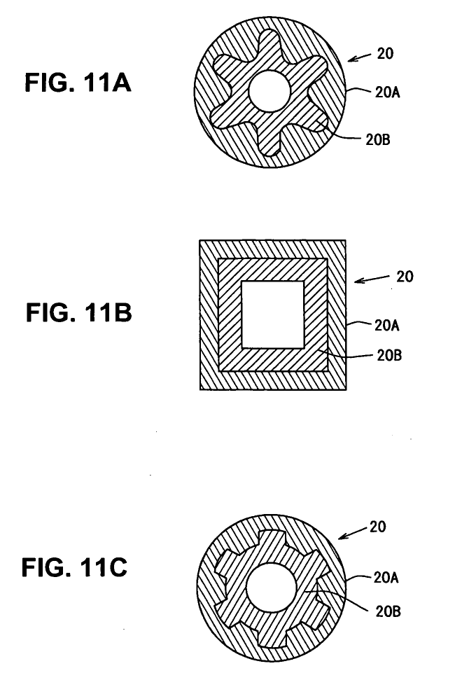

A specific sectional structure to allow the second steering shaft 20 to convey the rotational force (steering force by the steering wheel 27) and to provide the relative movement in the axial direction is illustrated in FIGS. 11A, 11B and 11C. In a structure illustrated in FIG. 11A, the inner shaft 20B includes a plurality of projections which extend radially at intervals of 60 degrees and the outer shaft 20A includes a plurality of recesses corresponding the projections. In a structure illustrated in FIG. 11B, the outer shaft 20A and the inner shaft 20B are formed in a squire shape, respectively. In a structure in FIG. 11C, the inner shaft 20B is formed in a spline-shaft shape and the outer shaft 20A is formed includes spline-shaped recesses. In these structures in FIGS. 11A, 11B and 11C, the both shafts 20A and 20B are configured so as to slide relatively, and thus by using either one of these structures, there can be provided the structure of these shafts 20A and 20B in which the rotational force can be conveyed and the relative movement in the axial direction can be obtained.

Herein, the universal joints 19 and 21 illustrated in FIG. 10 comprise yoke members 87 and 88 and a cross member 89 (so-called joint cross) which connects the yoke members 87 and 88. Also, an arrow F denotes a frontward direction of the vehicle and an arrow R denotes a rearward direction of the vehicle in FIG. 10.

An operation of the steering support structure described above will be described. As illustrated in FIGS. 3 and 4, the steering column 15 of the steering shaft 14 can be adjusted in the telescopic direction (the direction denoted by the arrow b in FIG. 3) along the longitudinally extending long holes 32 and 34. Also, it can be adjusted in the tilt direction (the direction denoted by the arrow a in FIG. 3) along the vertically extending long holes 36 and 36. Herein, since the meter portion 50 is connected with the steering column 15, it moves along with the steering column 15. As a result, the proper visibility of meter can be obtained.

Also, since the steering force of the steering wheel 27 is conveyed to the right and left wheels via the first steering shaft 18, second steering shaft 20, third steering shaft 24 and steering device 26, the front wheel can be steered.

Further, the dash panel 6 and the pedal support bracket 70 are moved rearward from the normal state of FIG. 2 to the sate of FIG. 13 during the vehicle frontal crash or the like. Herein, the axis member 84 of the pedal support bracket 70 is guided under faces of the guide pieces 85a and 85a of the pedal control bracket 85. Thus, the peal support bracket 70 is bent as illustrated in FIG. 13 and the brake pedal 71 can be prevented from jumping up toward the foot of the passenger A. Also, the hook member 82 attached to the pedal support bracket 70 moves in the direction denoted by the arrow e of FIG. 8 (rearward by a specified distance and then straightly slant rearward), and the steering shaft 14 is pulled rearward and bent with the bending point of the universal joints 19 and 21 as the joint as illustrated in FIG. 13. Herein, the outer shaft 20A and the inner shaft 20B, as the expanding portion, move relatively in the axial direction, and then after these shafts have expanded, they are separated as illustrated in FIG. 14. Thus, the position P1 (see FIG. 14) of the cross member 87 at the universal joint 19 is maintained at a substantially constant position regardless of before or after the vehicle crash. As a result, the steering shaft 14, specifically the first steering shaft 18 can be prevented from moving toward the passenger A properly, and the safety of the passenger A can be ensured.

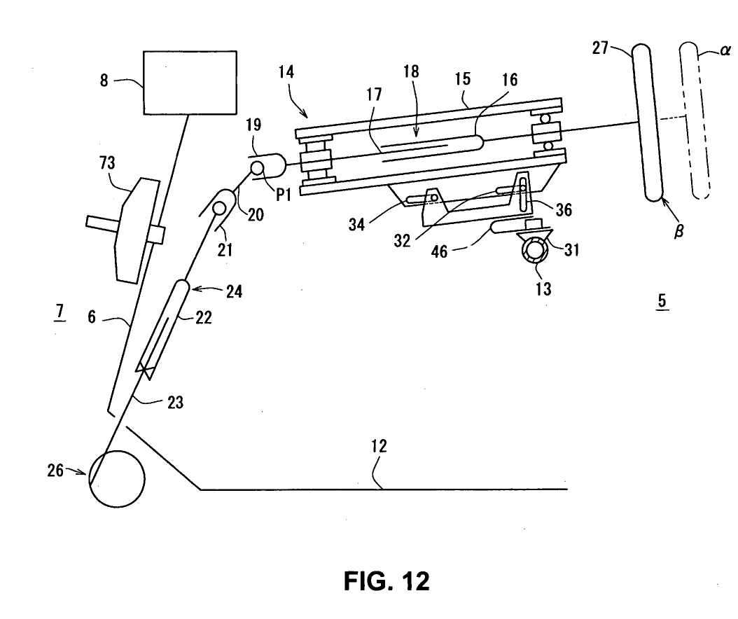

Also, when the passenger A is moved forward after the expansion of an air bag (not illustrated) installed at the steering wheel 27, the U-shaped plates 46 extend forward and the steering column 15 is moved forward by a specified distance along the long holes 32 and 34, as illustrated in FIG. 12. Further, the outer shaft 16 and the inner shaft 17 of the first steering shaft 18 are moved in the axial direction relatively so as to be shortened, and the steering wheel 27 is moved from a position α illustrated by a two-dotted broken line to a position β illustrated by a solid line in FIGS. 12 and 13 (2nd collapsible movement). Herein, the position P1 of the cross member 87 (see FIG. 10) of the universal joint 19 illustrated in FIGS. 3 and 12 is maintained at the substantially constant position regardless of before or after the vehicle crash.

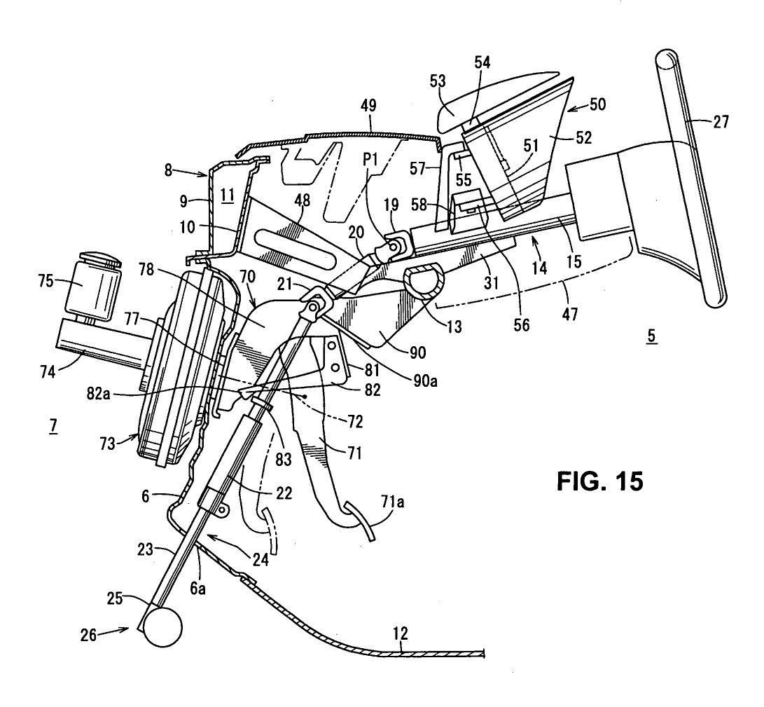

FIG. 15 illustrates another embodiment of the steering support structure of the vehicle. In the previous embodiment illustrated in FIG. 2, two brackets of the pedal control bracket 85 and the backup bracket 86 are provided at the rear portion of the pedal support bracket 70 and these brackets 85 and 86 are configured so as not to change their positions. In the present embodiment of FIG. 15, meanwhile, there is provided a pedal control bracket 90 as a rigidity member which is formed integrally with these brackets 85 and 86, and a rear end portion of the pedal control bracket 90 is welded to the steering support member 13. Thus, the bracket 90 is configured so as not to change its position. Also, guide pieces 90a and 85a which slant rearward and downward are formed integrally with lower ends of the pedal control bracket 90 like the structure illustrated in FIG. 9, and these guide pieces 90a guide the axis member 84 (see previous figures). The structure of this embodiment performs substantially the same operation and effects as the one of the previous embodiment. Accordingly, the same portions/parts as those of FIG. 2 are denoted by the same reference numerals, and their detailed explanations are omitted herein.

As described above, according to the present embodiment, there is provided the steering support structure of the vehicle, comprising the dash panel 6 provided at the front portion in the cabin 5 where the driver seat 1 for the passenger A is provided, the steering support member 13 provided behind the dash panel 6 and extending in the vehicle width direction, the steering shaft 14 supported by the steering support member 13, the steering device 26 coupled to the front end portion of the steering shaft 14, the steering wheel 27 attached to the rear end portion of the steering shaft 14, wherein the steering wheel 27 is provided so as to face the shoulder portion of the passenger A on the driver seat 1, and the steering shaft 14 is provided above the steering support member 13 and attached to the steering support member 13.

According to this structure, since the steering wheel 27 is provided so as to face the shoulder portion of the passenger A, the difference between the distance from the driver's hand located at the upper portion of the steering wheel 27 to the driver's shoulder portion and the distance from the driver's hand located at the lower portion of the steering wheel 27 to the driver's shoulder portion becomes extremely small. As a result, the handling of the steering wheel 27 can be improved, the sense of fatigue of the passenger A can be reduced, and the steering wheel 27 can be properly adjusted in the longitudinal direction of the vehicle according to the body size of the passenger A. Namely, the proper disposition of the steering wheel 27 with the reduced sense of fatigue can be attained.

Also, the steering shaft 14 is configured such that its position is adjustable, and there is provided the meter portion 50 which moves along with the steering shaft 14 and its position is adjustable. The position of the steering shaft 14 can be adjusted in both tilt and telescopic directions.

According to this structure, since the steering shaft 14 and the meter portion 50 move together, the both proper disposition of the steering wheel 27 and proper visibility of the meter can be obtained.

Further, there is provided the steering attaching bracket 30 to attach the steering shaft 14 to the steering support member 13, and the steering shaft 14 is fixed to the steering support member 13 by fastening the steering attaching bracket 30 from below.

According to this structure, since the steering shaft 14 is fixed to the steering support member 13 by fastening the steering attaching bracket 30 from below, the service of the steering shaft 14 can be facilitated.

Additionally, there is provided the instrument panel 49 above the steering shaft 14, and the instrument panel 49 is configured such that a part thereof (see the meter portion 50) is detachable, and the steering shaft 14 can be detached by detaching the part of the instrument panel 49 (see the meter portion 50) thereby.

According to this structure, all of the instrument panel 49 does not need to be detached, and by detaching only part (the meter portion 50), the steering shaft 14 can be removed. Accordingly, the maintenance and service can be facilitated.

Also, the part of the instrument panel 49 is provided at the meter portion 50.

According to this structure, all of the instrument panel 49 does not need to be detached, and by detaching only the meter portion 50, the steering shaft 14 can be removed. Accordingly, the maintenance and service can be facilitated. Also, this detachable structure of the meter portion 50 can simplify a structure around the instrument panel. Further, since there is provided no unnecessary slit structure, an appearance will not deteriorate.

Further, the meter portion 50 comprises the meter body 51 and the meter hood 53 which are integrally attached.

According to this structure, since the meter body 51 and the meter hood 53 are integrally attached or detached, the maintenance and service can be further facilitated.

Further, there is further provided the hook member 82 as the operating member which pulls the intermediate portion (see the third steering shaft 24) of the steering shaft 14 rearward during a vehicle frontal crash.

According to this structure, since the hook member 82 pulls the intermediate portion of the steering shaft 14 rearward during the vehicle frontal crash as illustrated in FIG. 13, the safety of the passenger A can be ensured by the control of the steering shaft 14.

Namely, both the proper disposition of the steering wheel 27, which provides the steering wheel 27 with the proper longitudinal adjustment and the reduced sense of fatigue, and the safety of the passenger by the control of the steering shaft 14 can be obtained.

Also, the steering shaft 14, as illustrated in FIGS. 2 and 3, comprises a plurality of shafts 18, 20 and 24 which are coupled via the joint portion (see the universal joints 19 and 21), the operating member (see the hook member 82) pulls the steering shaft 14 (see particularly the third steering shaft 24) such that the steering shaft 14 is bent rearward during the vehicle frontal crash.

According to this structure, when the steering shaft 14 is pulled rearward by the operating member (see the hook member 82) during the vehicle frontal crash, the pull is carried out by making use of the joint portion (see the universal joints 19 and 21). Thus, the safety by the control of the steering shaft 14 can be ensured further properly.

Also, the operating member (see the hook member 82) is attached at the dash lower panel 6 which is moved rearward during the vehicle frontal crash (the hook 82 is attached at the dash lower panel 6 via the pedal support bracket 70 in the present embodiment).

According to this structure, since the operating member (see the hook member 82) is attached at the dash lower panel 6 which is moved rearward first during the vehicle frontal crash, the steering shaft 14 can be pulled rearward at the appropriate timing.

Further, the operating member (see the hook member 82) is attached to the pedal support bracket 70 which is attached at the dash lower panel 6 to support the brake pedal 71 and is moved rearward and then slant downward during vehicle frontal crash.

This pedal support bracket 70 is configured so as to be a structure to prevent the brake pedal 71 from being moved rearward. According to this structure, since the pedal support bracket 70, which is moved rearward and then slant downward during vehicle frontal crash, is utilized, the steering shaft 14 can be pulled rearward surely without interfering with any other member when the operating member (see the hook member 82) pulls the steering shaft 14. Also, this structure can be made simple.

Also, there is further provided the engaging member (see the engaging ring 83) which prevents the operating member (see the hook member 82) from sliding at the portion of the steering shaft (see the third steering shaft 24) which corresponds to the operating member.

According to this structure, since the operating member (see the hook member 82) is prevented from sliding by the engaging member (see the engaging ring 83), the pull of the steering shaft (see the third steering shaft 24) by the operating member (see the hook member 82) can be attained further surely.

Further, there is further provided the expanding portion (see the outer shaft 20A and the inner shaft 20B) which is expandable in the axial direction during the vehicle frontal crash at the intermediate portion (see the second steering shaft 20) of the steering shaft 14.

According to this structure, the expanding portion (see the outer shaft 20A and the inner shaft 20B) provided at the intermediate portion (see the second steering shaft 20) of the steering shaft 14 expands in the axial direction during the vehicle frontal direction (see FIG. 13). Accordingly, the steering wheel 27 can be prevented from moving toward the passenger A, and thus the safety by the control of the steering shaft 14 can be ensured.

Also, the intermediate portion (see the second steering shaft 20) of the steering shaft comprises a plurality of shafts 20A and 20B which are connected with the overlap. These shafts 20A and 20B can covey the steering force by the steering wheel 27 and move relatively in the axial direction.

According to this structure, the expanding portion which is expandable at least in the axial direction during the vehicle frontal crash can be made simple.

Also, this expanding portion (see the outer shaft 20A and the inner shaft 20B) is configured so as to be separated after its expansion (see FIG. 14).

According to this structure, since the expanding portion (see the outer shaft 20A and the inner shaft 20B) is separated after its expansion, the control of the steering shaft 14 can be attained further surely, and the safety of the passenger A can be ensured further properly.

Additionally, there is further provided the hook member 82 to promote the expansion (see FIG. 13) and separation (see FIG. 14) of the expanding portion (see the outer shaft 20A and the inner shaft 20B) by pulling the intermediate portion of the steering shaft 14 rearward during the vehicle frontal crash.

According to this structure, since the expansion and separation of the expanding portion (see the outer shaft 20A and the inner shaft 20B) is promoted by the hook member 82, the expansion and separation cane be attained surely.

Also, the hook member 82 is attached at the dash lower panel 6 which is moved rearward during the vehicle frontal crash. In the present embodiment, the hook member 82 is attached at the dash lower panel 6 via the pedal support bracket 70.

According to this structure, since the hook member 82 is attached at the dash lower panel 6 which is moved rearward first during the vehicle frontal crash, the intermediate portion of the steering shaft 14 can be moved rearward at the appropriate timing.

Further, the hook member 82 is attached to the pedal support bracket 70 which is attached at the dash lower panel 6 to support the brake pedal 71 and is moved rearward and then slant downward during vehicle frontal crash. This pedal support bracket 70 is configured so as to be the structure which prevents the brake pedal 71 from being moved rearward.

According to this structure, since the pedal support bracket 70, which is moved rearward and then slant downward during vehicle frontal crash, is utilized, the intermediate portion of the steering shaft 14 can be pulled rearward surely without interfering with any other member when the operating member (see the hook member 82) pulls the intermediate portion of the steering shaft 14. Also, this structure can be made simple.

The present invention should not limited to the above-described embodiments, but any other modifications and improvements may be applied within the scope of a sprit of the present invention.

1. A steering support structure of a vehicle, comprising
a dash panel provided at a front portion in a cabin where a seat for a passenger is provided;
a steering support member provided behind said dash panel and extending in a vehicle width direction;
a steering shaft supported by said steering support member;
a steering device coupled to a front end portion of said steering shaft;
a steering wheel attached to a rear end portion of said steering shaft,
wherein said steering wheel is provided so as to face a shoulder portion of the passenger on the seat, and said steering shaft is provided above said steering support member and attached to said steering support member.

2. A steering support structure of a vehicle of claim 1, wherein said steering shaft is configured such that a position thereof is adjustable, and there is provided a meter portion which moves along with the steering shaft and whose position is adjustable.

3. A steering support structure of a vehicle of claim 1, wherein there is provided a steering attaching bracket to attach said steering shaft to said steering support member, and said steering shaft is fixed to said steering support member by fastening said steering attaching bracket from below.

4. A steering support structure of a vehicle of claim 3, wherein there is provided an instrument panel above the steering shaft, and said instrument panel is configured such that a part thereof is detachable, whereby said steering shaft can be detached by detaching the part of the instrument panel.

5. A steering support structure of a vehicle of claim 4, wherein said part of the instrument panel is provided at said meter portion.

6. A steering support structure of a vehicle of claim 5, wherein said meter portion comprises a meter body and a meter hood which are integrally attached.

7. A steering support structure of a vehicle of claim 1, wherein there is further provided an operating member which pulls an intermediate portion of said steering shaft rearward during a vehicle frontal crash.

8. A steering support structure of a vehicle of claim 7, wherein said steering shaft comprises a plurality of shafts which are coupled via a joint portion, said operating member pulls said steering shaft such that said steering shaft is bent rearward during the vehicle frontal crash.

9. A steering support structure of a vehicle of claim 7, wherein said operating member is attached at said dash panel which is moved rearward during the vehicle frontal crash.

10. A steering support structure of a vehicle of claim 9, wherein said operating member is attached to a pedal attaching bracket which is attached at said dash panel to support a pedal and is moved rearward and then slant downward during vehicle frontal crash.

11. A steering support structure of a vehicle of claim 8, wherein there is further provided an engaging member which prevents said operating member from sliding at a portion of said steering shaft which corresponds to said operating member.

12. A steering support structure of a vehicle of claim 1, wherein there is further provided an expanding portion which is expandable in an axial direction during a vehicle frontal crash at an intermediate portion of said steering shaft.

13. A steering support structure of a vehicle of claim 12, wherein said intermediate portion of the steering shaft comprises a plurality of shafts which are connected with an overlap.

14. A steering support structure of a vehicle of claim 12, wherein said expanding portion is configured so as to be separated after an expansion thereof.

15. A steering support structure of a vehicle of claim 12, wherein there is further provided an operating member to promote an expansion and separation of said expanding portion by pulling said intermediate portion of the steering shaft rearward during the vehicle frontal crash.

16. A steering support structure of a vehicle of claim 15, wherein said operating member is attached at said dash panel which is moved rearward during the vehicle frontal crash.

17. A steering support structure of a vehicle of claim 16, wherein said operating member is attached to a pedal attaching bracket which is attached at said dash panel to support a pedal and is moved rearward and then slant downward during vehicle frontal crash.

18. A steering support structure of a vehicle, comprising
a dash panel provided at a front portion in a cabin where a seat for a passenger is provided;
a steering support member provided behind said dash panel and extending in a vehicle width direction;
a steering shaft supported by said steering support member;
a steering device coupled to a front end portion of said steering shaft;
a steering wheel attached to a rear end portion of said steering shaft,
wherein said steering wheel is provided so as to face a shoulder portion of the passenger on the seat, and there is provided an operating member which pulls an intermediate portion of said steering shaft rearward during a vehicle frontal crash.

19. A steering support structure of a vehicle, comprising
a dash panel provided at a front portion in a cabin where a seat for a passenger is provided;
a steering support member provided behind said dash panel and extending in a vehicle width direction;
a steering shaft supported by said steering support member;
a steering device coupled to a front end portion of said steering shaft;
a steering wheel attached to a rear end portion of said steering shaft,
wherein said steering wheel is provided so as to face a shoulder portion of the passenger on the seat, and there is provided an expanding portion which is expandable in an axial direction during a vehicle frontal crash at an intermediate portion of said steering shaft.

20. A steering support structure of a vehicle, comprising
a dash panel provided at a front portion in a cabin where a seat for a passenger is provided;
a steering support member provided behind said dash panel and extending in a vehicle width direction;
a steering shaft supported by said steering support member;
a steering device coupled to a front end portion of said steering shaft;
a steering wheel attached to a rear end portion of said steering shaft,
wherein said steering wheel is provided so as to face a shoulder portion of the passenger on the seat, said steering shaft is provided above said steering support member and attached to said steering support member, there is provided an operating member which pulls an intermediate portion of said steering shaft rearward during a vehicle frontal crash, and there is provided an expanding portion which is expandable in an axial direction during the vehicle frontal crash at the intermediate portion of said steering shaft.
